(19) United States
(12) Patent Application Publication
(10) Pub. No.: US 2026/0230971 A1
(43) Pub. Date: Aug. 6, 2026

(54) METHOD AND APPARATUS FOR CHANGING UPLINK NODE IN WIRELESS COMMUNICATION SYSTEM

(71) Applicant: Samsung Electronics Co., Ltd., Gyeonggi-do (KR)

(72) Inventors: Sooeun SONG, Gyeonggi-do (KR); Suhwook KIM, Gyeonggi-do (KR); Jaehong YI, Gyeonggi-do (KR); Changsung LEE, Gyeonggi-do (KR); Hyeondeok JANG, Gyeonggi-do (KR)

(21) Appl. No.: 19/150,721

(22) PCT Filed: Nov. 20, 2023
(86) PCT No.: PCT/KR2023/018656

§ 371 Date: Jul. 24, 2025

(30) Foreign Application Priority Data
Jan. 25, 2023 (KR) 10-2023-0009285

(51) Int. Cl. H04W 36/08; H04B 17/318; H04L 41/16; H04W 74/0833

(52) U.S. Cl. CPC H04W 36/08; H04B 17/328; H04L 41/16; H04W 74/0833

(57) ABSTRACT

The present disclosure relates to a 5G, pre-5G or 6G communication system for supporting a data transfer rate higher than that of a 4G communication system such as LTE. This method by which a first node changes an uplink node in a wireless communication system may comprise the operations of: transmitting artificial intelligence (AI) uplink model setup information to a user equipment (UE) and receiving an uplink inference result based on the AI uplink model setup information from the UE; determining, on the basis of the uplink inference result based on the AI uplink model setup information, a second node to be added as an uplink node for the UE; transmitting an uplink node addition request to the second node and receiving a response to the uplink node addition request from the second node; performing a random access procedure with the UE through the second node; and receiving an uplink node change completion message from the second node.

### TECHNICAL FIELD

The disclosure relates to a method and device for changing an uplink node in a wireless communication system.

### BACKGROUND ART

Considering the development of wireless communication from generation to generation, the technologies have been developed mainly for services targeting humans, such as voice calls, multimedia services, and data services. Following the commercialization of 5G (5th-generation) communication systems, it is expected that the number of connected devices will exponentially grow. Increasingly, these will be connected to communication networks. Examples of connected things may include vehicles, robots, drones, home appliances, displays, smart sensors connected to various infrastructures, construction machines, and factory equipment. Mobile devices are expected to evolve in various form-factors, such as augmented reality glasses, virtual reality headsets, and hologram devices. In order to provide various services by connecting hundreds of billions of devices and things in the 6G (6th-generation) era, there have been ongoing efforts to develop improved 6G communication systems. For these reasons, 6G communication systems are referred to as beyond-5G systems.

6G communication systems, which are expected to be commercialized around 2030, will have a peak data rate of tera (1,000 giga)-level bps and a radio latency less than 100 μsec, and thus will be 50 times as fast as 5G communication systems and have the 1/10 radio latency thereof.

In order to accomplish such a high data rate and an ultra-low latency, it has been considered to implement 6G communication systems in a terahertz band (for example, 95 GHz to 3 THz bands). It is expected that, due to severer path loss and atmospheric absorption in the terahertz bands than those in mmWave bands introduced in 5G, technologies capable of securing the signal transmission distance (that is, coverage) will become more crucial. It is necessary to develop, as major technologies for securing the coverage, radio frequency (RF) elements, antennas, novel waveforms having a better coverage than orthogonal frequency division multiplexing (OFDM), beamforming and massive multiple input multiple output (MIMO), full dimensional MIMO (FD-MIMO), array antennas, and multiantenna transmission technologies such as large-scale antennas. In addition, there has been ongoing discussion on new technologies for improving the coverage of terahertz-band signals, such as metamaterial-based lenses and antennas, orbital angular momentum (OAM), and reconfigurable intelligent surface (RIS).

Moreover, in order to improve the spectral efficiency and the overall network performances, the following technologies have been developed for 6G communication systems: a full-duplex technology for enabling an uplink transmission and a downlink transmission to simultaneously use the same frequency resource at the same time; a network technology for utilizing satellites, high-altitude platform stations (HAPS), and the like in an integrated manner; an improved network structure for supporting mobile base stations and the like and enabling network operation optimization and automation and the like; a dynamic spectrum sharing technology via collision avoidance based on a prediction of spectrum usage; an use of artificial intelligence (AI) in wireless communication for improvement of overall network operation by utilizing AI from a designing phase for developing 6G and internalizing end-to-end AI support functions; and a next-generation distributed computing technology for overcoming the limit of UE computing ability through reachable super-high-performance communication and computing resources (such as mobile edge computing (MEC), clouds, and the like) over the network. In addition, through designing new protocols to be used in 6G communication systems, developing mechanisms for implementing a hardware-based security environment and safe use of data, and developing technologies for maintaining privacy, attempts to strengthen the connectivity between devices, optimize the network, promote softwarization of network entities, and increase the openness of wireless communications are continuing.

It is expected that research and development of 6G communication systems in hyper-connectivity, including person to machine (P2M) as well as machine to machine (M2M), will allow the next hyper-connected experience. Particularly, it is expected that services such as truly immersive extended reality (XR), high-fidelity mobile hologram, and digital replica could be provided through 6G communication systems. In addition, services such as remote surgery for security and reliability enhancement, industrial automation, and emergency response will be provided through the 6G communication system such that the technologies could be applied in various fields such as industry, medical care, automobiles, and home appliances.

### DETAILED DESCRIPTION OF THE INVENTION

### Technical Problem

As mobile communication systems evolve, various frequency bands may be utilized, leading to potential coverage bottlenecks due to limited uplink frequency resources, thereby necessitating solutions.

### Technical Solution

In various embodiments of the disclosure, a method for changing an uplink node by a first node in a wireless communication system may comprise transmitting, to a user equipment (UE), artificial intelligence (AI) uplink model setup information and receiving, from the UE, an uplink inference result based on the AI uplink model setup information, determining to add a second node as an uplink node for the UE based on the uplink inference result based on the AI uplink model setup information, transmitting, to the second node, an uplink node addition request and receiving, from the second node, a response to the uplink node addition request, performing a random access procedure with the UE through the second node, and receiving, from the second node, an uplink node change complete message.

In various embodiments of the disclosure, a method for changing an uplink node by a first node in a wireless communication system may comprise transmitting, to a user equipment (UE), artificial intelligence (AI) uplink model setup information, receiving, from the UE through a second node, an uplink inference result based on the AI uplink model setup information, receiving, from the second node, a request for changing an uplink node for the UE from the second node to a third node and transmitting, to the second node, a response to the request for changing the uplink node, performing a random access procedure with the UE through the third node, and receiving, from the third node, an uplink node change complete message and transmitting, to the second node, the uplink node change complete message and a message for requesting uplink release of the second node.

In various embodiments of the disclosure, a first node in a wireless communication system may comprise a transceiver, and at least one processor. The at least one processor may be configured to transmit, to a user equipment (UE), artificial intelligence (AI) uplink model setup information and receive, from the UE, an uplink inference result based on the AI uplink model setup information, determine to add a second node as an uplink node for the UE based on the uplink inference result based on the AI uplink model setup information, transmit, to the second node, an uplink node addition request and receive, from the second node, a response to the uplink node addition request, perform a random access procedure with the UE through the second node, and receive, from the second node, an uplink node change complete message.

In various embodiments of the disclosure, a first node in a wireless communication system may comprise a transceiver, and at least one processor. The at least one processor may be configured to transmit, to a user equipment (UE), artificial intelligence (AI) uplink model setup information, receive, from the UE through a second node, an uplink inference result based on the AI uplink model setup information, receive, from the second node, a request for changing an uplink node for the UE from the second node to a third node and transmit, to the second node, a response to the request for changing the uplink node, perform a random access procedure with the UE through the third node, and receive, from the third node, an uplink node change complete message and transmit, to the second node, the uplink node change complete message and a message for requesting uplink release of the second node.

Objects of the disclosure are not limited to the foregoing, and other unmentioned objects would be apparent to one of ordinary skill in the art from the following description.

### Advantageous Effects

According to various embodiments of the disclosure, wide coverage may be secured through decoupling of downlink and uplink.

According to various embodiments of the disclosure, communication capabilities may be enhanced by decoupling of downlink and uplink, and resource waste may be decreased.

According to various embodiments of the disclosure, communication capabilities may be enhanced by efficiently changing uplink nodes in a downlink-and-uplink decoupled environment.

### BRIEF DESCRIPTION OF DRAWINGS

FIG. 1 illustrates an environment in which downlink transmission and uplink transmission are decoupled according to an embodiment of the disclosure;

FIG. 2 illustrates a procedure for changing an uplink node according to an embodiment of the disclosure;

FIG. 3 illustrates a procedure for changing an uplink node according to an embodiment of the disclosure;

FIG. 4A illustrates a more detailed operation in which a UE receives AI-UL model setup information, performs inference on uplink, and transmits an AI-UL output report according to an embodiment of the disclosure;

FIG. 4B illustrates an operation in which a gNB determines a target UL mode and a UL node change based on an AI-UL model managed by the gNB.

FIG. 5A illustrates a more detailed operation in which a UE receives AI-UL model setup information, performs inference on uplink, and transmits an AI-UL output report according to an embodiment of the disclosure;

FIG. 5B illustrates an operation in which a gNB determines a target UL mode and a UL node change based on an AI-UL model managed by the gNB according to an embodiment of the disclosure;

FIG. 6 illustrates an operation when a source gNB fails to change a UL node after a UE receives AI-UL model setup information, performs inference on uplink, and reports AI-UL output according to an embodiment of the disclosure;

FIG. 7 illustrates an operation of adding a UL node by a source gNB according to an embodiment of the disclosure;

FIG. 8 illustrates an operation of changing a UL node by a source UL node according to an embodiment of the disclosure;

FIG. 9 illustrates a detailed operation of a UL node change procedure according to an embodiment of the disclosure;

FIG. 10 illustrates a detailed operation of a UL node change procedure according to an embodiment of the disclosure;

FIG. 11 is a view illustrating a configuration of a node according to an embodiment of the disclosure; and

FIG. 12 is a view illustrating a configuration of a UE according to an embodiment of the disclosure.

### MODE FOR CARRYING OUT THE INVENTION

Hereinafter, embodiments of the present invention are described in detail with reference to the accompanying drawings. The same reference denotations may be used to refer to the same or similar elements throughout the specification and the drawings. When making the gist of the present disclosure unclear, the detailed description of known functions or configurations is skipped.

In describing the embodiments, the description of technologies that are known in the art and are not directly related to the present invention is omitted. This is for further clarifying the gist of the present disclosure without making it unclear.

For the same reasons, some elements may be exaggerated or schematically shown. The size of each element does not necessarily reflects the real size of the element. The same reference numeral is used to refer to the same element throughout the drawings.

Advantages and features of the disclosure, and methods for achieving the same may be understood through the embodiments to be described below taken in conjunction with the accompanying drawings. However, the present disclosure is not limited to the embodiments disclosed herein, and various changes may be made thereto. The embodiments disclosed herein are provided only to inform one of ordinary skilled in the art of the category of the present disclosure. The present disclosure is defined only by the appended claims. The same reference numeral denotes the same element throughout the specification.

It should be appreciated that the blocks in each flowchart and combinations of the flowcharts may be performed by computer program instructions. Since the computer program instructions may be equipped in a processor of a general-use computer, a special-use computer or other programmable data processing devices, the instructions executed through a processor of a computer or other programmable data processing devices generate means for performing the functions described in connection with a block(s) of each flowchart. Since the computer program instructions may be stored in a computer-available or computer-readable memory that may be oriented to a computer or other programmable data processing devices to implement a function in a specified manner, the instructions stored in the computer-available or computer-readable memory may produce a product including an instruction means for performing the functions described in connection with a block(s) in each flowchart. Since the computer program instructions may be equipped in a computer or other programmable data processing devices, instructions that generate a process executed by a computer as a series of operational steps are performed over the computer or other programmable data processing devices and operate the computer or other programmable data processing devices may provide steps for executing the functions described in connection with a block(s) in each flowchart.

Further, each block may represent a module, segment, or part of a code including one or more executable instructions for executing a specified logical function(s). Further, it should also be noted that in some replacement embodiments, the functions mentioned in the blocks may occur in different orders. For example, two blocks that are consecutively shown may be performed substantially simultaneously or in a reverse order depending on corresponding functions.

As used herein, the term “unit” means a software element or a hardware element such as a field-programmable gate array (FPGA) or an application specific integrated circuit (ASIC). A unit plays a certain role. However, the term “unit” is not limited as meaning a software or hardware element. A ‘unit’ may be configured in a storage medium that may be addressed or may be configured to reproduce one or more processors. Accordingly, as an example, a ‘unit’ includes elements, such as software elements, object-oriented software elements, class elements, and task elements, processes, functions, attributes, procedures, subroutines, segments of program codes, drivers, firmware, microcodes, circuits, data, databases, data architectures, tables, arrays, and variables. Functions provided within the components and the ‘units’ may be combined into smaller numbers of components and ‘units’ or further separated into additional components and ‘units’. Further, the components and ‘units’ may be implemented to execute one or more CPUs in a device or secure multimedia card.

Hereinafter, the base station may be an entity allocating a resource to the UE and may be at least one of a NodeB, Node B, base station (BS), eNode B (eNB), gNode B (gNB), radio access unit, base station controller, or node on network. The UE may include UE (user equipment), MS (mobile station), cellular phone, smartphone, computer, or multimedia system capable of performing communication functions. The embodiments of the present invention may also apply to other communication systems with similar technical background or channel form. Further, embodiments of the present invention may be modified in such a range as not to significantly depart from the scope of the present invention under the determination by one of ordinary skill in the art and such modifications may be applicable to other communication systems.

As used herein, terms for identifying access nodes, terms denoting network entities or network functions (NFs), terms denoting messages, terms denoting inter-network entity interfaces, and terms denoting various pieces of identification information are provided as an example for ease of description. Thus, the disclosure is not limited by the terms, and such terms may be replaced with other terms denoting objects with equivalent technical concept.

For ease of description, hereinafter, some of the terms and names defined in the 3rd generation partnership project long term evolution (3GPP LTE) standards may be used. However, the disclosure is not limited by such terms and names and may be likewise applicable to systems conforming to other standards.

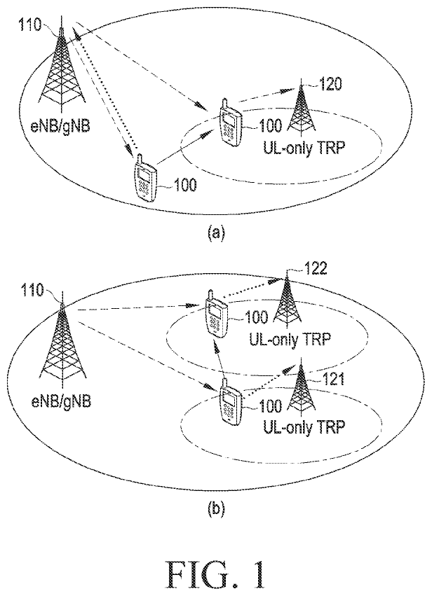

FIG. 1 illustrates an environment in which downlink transmission and uplink transmission are decoupled according to an embodiment of the disclosure.

In next-generation communication systems, when a relatively high frequency band is used, high path loss (PL) and limited UE power may cause bottlenecks in coverage in the case of uplink transmission. Therefore, to solve this problem, a UL-only Tx/Rx point (TRP) may be deployed as a node for uplink transmission only to decouple uplink transmission and downlink transmission, securing wide coverage for uplink transmission. As described above, there is a need for a method for changing an uplink node in an environment in which a UL-only TRP is present.

Referring to FIG. 1, when the UE 100 moves into the coverage of the UL-only TRP 120 while the UE 100 performs both downlink transmission and uplink transmission through the control of the eNB/gNB 100, as illustrated in FIG. 1(a), uplink transmission may be separated from downlink transmission for efficient uplink transmission. To this end, the UE 100 may change the uplink transmission node from the eNB/gNB 100 to the UL-only TRP 120 while maintaining the downlink transmission node as the eNB/gNB 100.

Further, as illustrated in FIG. 1(b), when the UE 100 moves into the coverage of the UL-only TRP 122 in a state in which the UE 100 is located in the coverage of the UL-only TRP 121, performs downlink transmission under the control of eNB/gNB 100, and performs uplink transmission under the control of the UL-only TRP 121, the uplink transmission node needs to be changed for efficient uplink transmission. To this end, the UE 100 may change the uplink transmission node from the UL-only TRP 121 to the UL-only TRP 122 while maintaining the downlink transmission node as the eNB/gNB 100.

Hereinafter, procedures performed when changing the uplink transmission node of the UE are described in detail.

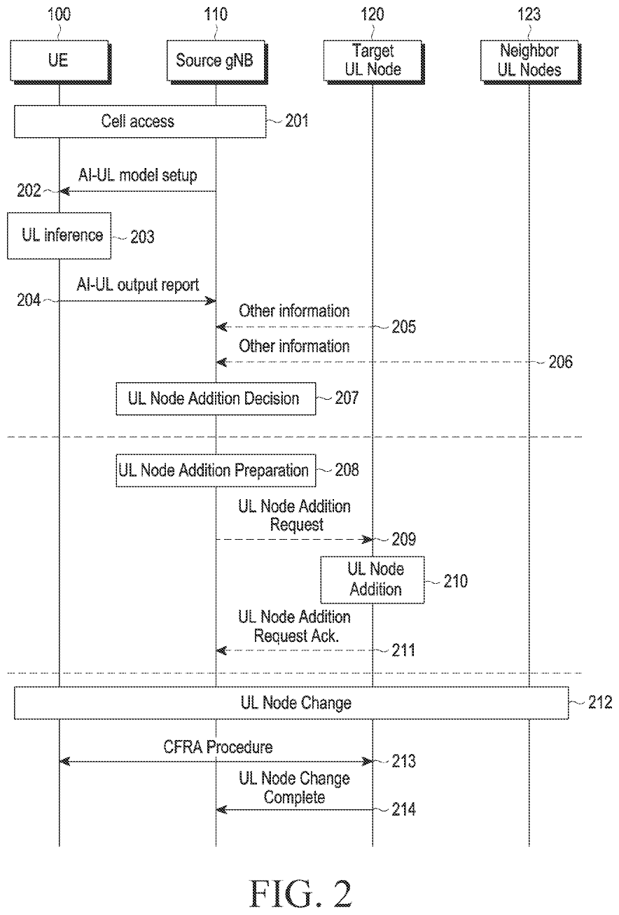

FIG. 2 illustrates a procedure for changing an uplink node according to an embodiment of the disclosure. In FIG. 2, it is assumed that the uplink node is changed to the target UL node 120 when both downlink transmission and uplink transmission are performed on the UE 100 under the control of the source gNB 110.

Referring to FIG. 2, in operation 201, the UE 100 may perform a cell access procedure with a source base station (source gNB) 100 according to a general procedure. The cell access procedure may include a radio resource control (RRC) setup, reconfiguration, and resetting procedure.

The UE 100 may receive information for AI-UL model setup from the source gNB 110 in operation 202, periodically perform an inference operation on the uplink based on the received AI-UL model setup information in operation 203, and transmit an AI-UL output report to the source gNB 110 based on the inference result in operation 204.

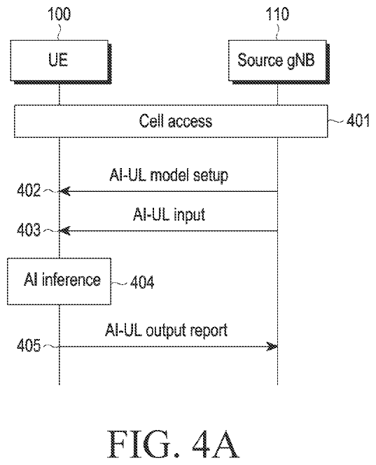

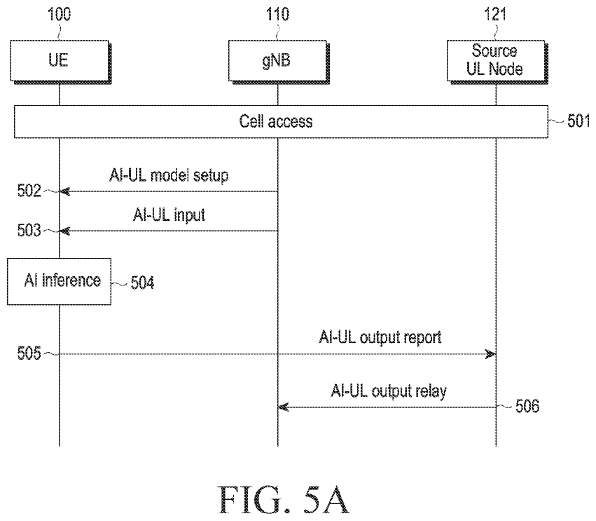

A more detailed operation in which the UE 100 receives the AI-UL model setup information, performs inference on uplink, and transmits the AI-UL output report is described below in the description of FIGS. 4 and 6.

The source gNB 110 receiving the AI-UL output report from the UE 100 may receive information about each uplink node from peripheral uplink nodes (e.g., the target UL node 120 and neighbor UL node 123) in operations 205 and 206. In an embodiment, the peripheral uplink nodes (e.g., the target UL node 120 and neighbor UL node 123) may be determined based on the AI-UL output report received from the UE 100. The information received from the peripheral uplink nodes (e.g., the target UL node 120 and neighbor UL node 123) may include cell load of each node, wireless communication-related capability information, or the like.

In operation 207, the source gNB 100 may determine to add a UL node based on the AI-UL output report received from the UE 100 and information received from the uplink nodes (e.g., the target UL node 120 and neighbor UL node 123) and perform a preparation operation for adding a UL node in operation 208.

As the preparation operation for adding a UL node, in operation 209, the source gNB 100 may transmit a UL node addition request message to the target UL node 120. In operation 210, the target UL node 120 may add a UL node according to the request of the source gNB 100 and, in operation 211, transmit a UL node addition request response message to the source gNB 100.

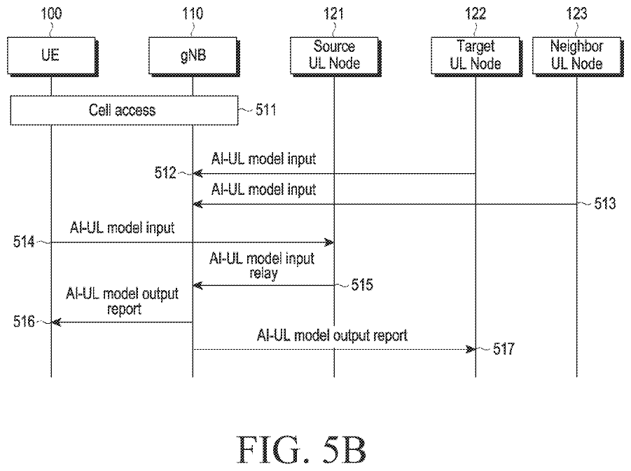

A detailed operation of determining and preparing to add a UL node in the source gNB 110 is described below with reference to FIG. 7.

As the preparation operation for adding a UL node is completed, a UL node change operation may be performed in operation 212. As the UL node change operation, a contention free random access (CFRA) procedure may be performed between the UE 100 and the target UL node 120 in operation 213, and the UL node change procedure may be completed as the target UL node 120 transmits a UL node change complete message to the source gNB 110 in operation 214.

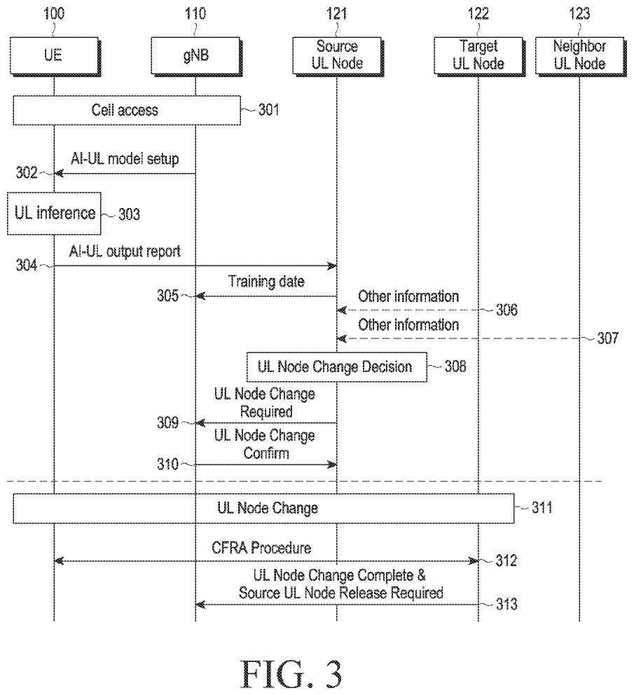

FIG. 3 illustrates a procedure for changing an uplink node according to an embodiment of the disclosure. In FIG. 3, it is assumed that the uplink node is changed to the target UL node 122 when uplink transmission to the UE 100 is performed under the control of the gNB 110 and uplink transmission is performed under the control of the source UL node 121.

Referring to FIG. 3, in operation 301, the UE 100 may perform a cell access procedure with the gNB 110 and the source UL node 121 according to a general procedure. The cell access procedure may include a radio resource control (RRC) setup, reconfiguration, and resetting procedure.

The UE 100 may receive information for AI-UL model setup from the gNB 110 in operation 302, periodically perform an inference operation on the uplink based on the received AI-UL model setup information in operation 303, and transmit an AI-UL output report to the source UL node 121 based on the inference result in operation 304. The AI-UL output report transmitted from the UE 100 to the source UL node 121 may be transferred to the gNB 110 in operation 305 and applied to the AI-UL mode managed by the gNB 110.

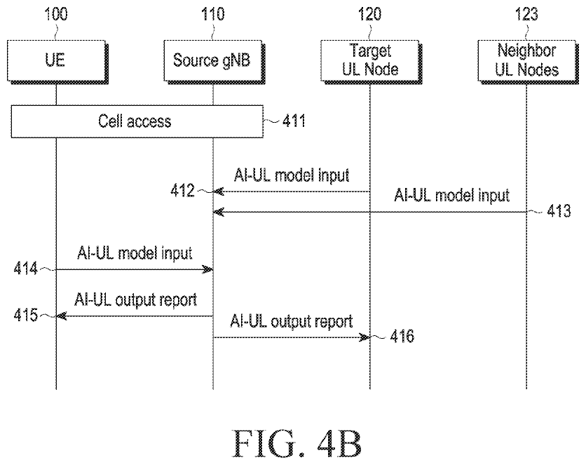

A more detailed operation in which the UE 100 receives the AI-UL model setup information, performs inference on uplink, and transmits the AI-UL output report is described below in the description of FIG. 5.

The source UL node 121 receiving the AI-UL output report from the UE 100 may receive information about each uplink node from peripheral uplink nodes (e.g., the target UL node 122 and neighbor UL node 123) in operations 306 and 307. In an embodiment, the peripheral uplink nodes (e.g., the target UL node 122 and neighbor UL node 123) may be determined based on the AI-UL output report received from the UE 100. The information received from the peripheral uplink nodes (e.g., the target UL node 122 and neighbor UL node 123) may include cell load of each node, wireless communication-related capability information, or the like.

In operation 308, the source UL node 121 may determine to change the UL node based on the information received from the uplink nodes (e.g., the target UL node 122 and neighbor UL node 123), transmit a UL node change request message to the gNB 110 in operation 309, and receive a UL node change identification message from the gNB 110 in operation 310. Thereafter, in operation 311, the UL node change operation may be performed.

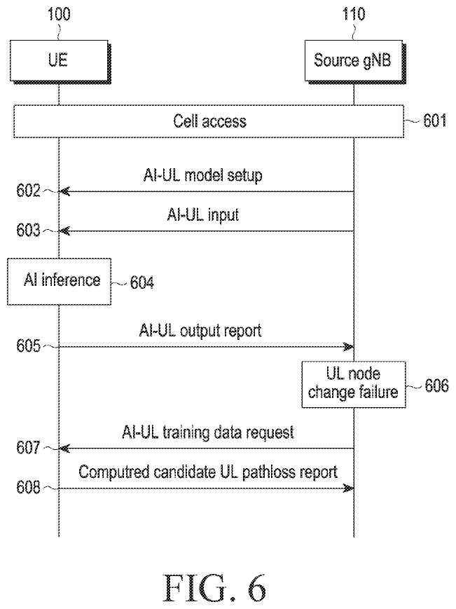

A detailed operation of determining a UL node change and performing a UL node change in the source UL node 121 is described below with reference to FIG. 8.

As the operation for changing the UL node, a contention free random access (CFRA) procedure may be performed between the UE 100 and the target UL node 122 in operation 312, and the UL node change procedure may be completed as the target UL node 122 transmits a UL node change complete message and a source UL node release request message to the gNB 110 in operation 313.

FIG. 4A illustrates a more detailed operation in which a UE receives AI-UL model setup information, performs inference on uplink, and transmits an AI-UL output report according to an embodiment of the disclosure. In FIG. 4A, it is assumed that the uplink node is changed to the target UL node 120 when both downlink transmission and uplink transmission are performed on the UE 100 under the control of the source gNB 110.

Referring to FIG. 4A, in operation 401, the UE 100 may perform a cell access procedure with a source base station (source gNB) 110 according to a general procedure. The cell access procedure may include a radio resource control (RRC) setup, reconfiguration, and resetting procedure.

The UE 100 may receive information for AI-UL model setup from the source gNB 110 in operation 402.

According to an embodiment, the information for AI-UL model setup may include basic information about the AI model (e.g., the number of layers, the number of nodes, connection information with nodes, the AI-UL model input/output format, and the activation function). According to an embodiment, the information for AI-UL model setup may include an UL node path loss calculation indicator, a target UL node determination indicator, or an indicator indicating whether to change the UL node as an indicator for determining the AI-UL model output type. According to an embodiment, the information for AI-UL model setup may include a message for triggering to allow the base station to perform AI inference or the inference period determined by the UE 100 considering the moving speed or remaining battery level or the period value determined during AI-UL model setup as the indicator indicating the type of the inference period. According to an embodiment, the information for AI-UL model setup may include information about the number of candidate target UL nodes to be reported by the UE 100. According to an embodiment, the information for AI-UL model setup may include information regarding, e.g., the event condition and threshold for UL node change as the information regarding the UL node change trigger event.

The UE 100 may receive an AI-UL input from the source gNB 110 in operation 403. According to an embodiment, the AI-UL input may include location information, identification information, and cell/wireless capability information about the candidate UL node(s). According to an embodiment, considering a case in which the output type is changed after the AI-UL model setup information is transmitted, the AI-UL input may include an indicator indicating the output type of the AI model. According to an embodiment, the information to be reported by the UE 100 in the measurement configuration may be added to the indicator indicating the output type of the AI model, which may be set in the RRC reconfiguration information. According to an embodiment, an inference period may be included. When the inference period type indicator included in the AI-UL model setup indicates the period determined during the AI-UL model setup, the AI-UL input may include an indicator indicating a change in the AI inference period and a value indicating the changed period. When a triggering message for performing AI inference is transmitted from the base station as the inference period type indicator included in the AI-UL model setup, the AI-UL input may include trigger information for performing AI inference. According to an embodiment, the AI-UL input may include data related to the location and movement of the UE 100.

The UE 100 performs an inference operation on the uplink based on the received AI-UL model setup information and AI-UL input in operation 404, and may transmit an AI-UL output report to the source gNB 110 based on the inference result in operation 405.

According to an embodiment, the UE 100 may request the source gNB 110 to change the UL node by inferring the optimal target UL node based on the current location, movement direction, and expected path loss of the UE 100 in the inference process for the uplink. In this case, the AI-UL output report may include the identifier of the optimal target UL node inferred by the UE 100, the number and identifier of candidate target UL node(s), the type of UL node change trigger event, and information about whether the event occurs. In an embodiment, the UL node change trigger event may be an event in which the reference signal received power (RSRP) for the candidate UL node exceeds a threshold, or an event in which the RSRP expected for the candidate UL node exceeds the RSRP expected for the source gNB 110.

According to an embodiment, the UE 100 may allow the source gNB 110 to determine whether to change the UL node by inferring the path loss expected for the candidate UL nodes in the inference process for the uplink and reporting it to the source gNB 110. In this case, the AI-UL output report may include information about the number of candidate target UL nodes and a set indicating path loss values of candidate UL nodes.

According to an embodiment, the UE 100 may infer a path loss expected for the source gNB 110 in the inference process for the uplink and request the source gNB 110 to change the UL node. In this case, the AI-UL output report may include location information and movement data of the UE 100, and information about whether the UL node change trigger event occurs. In an embodiment, the UL node change trigger event may be an event in which the RSRP expected for the source gNB 110 exceeds the threshold.

FIG. 4B illustrates an operation in which a gNB determines a target UL mode and a UL node change based on an AI-UL model managed by the gNB. In FIG. 4B, it is assumed that the uplink node is changed to the target UL node 120 when both downlink transmission and uplink transmission are performed on the UE 100 under the control of the source gNB 110.

Referring to FIG. 4B, in operation 411, the UE 100 may perform a cell access procedure with a source base station (source gNB) 110 according to a general procedure. The cell access procedure may include a radio resource control (RRC) setup, reconfiguration, and resetting procedure.

In operations 412 and 413, the source gNB 110 may receive location information, identifier, cell capability information, and/or current UL SRS-RSRP and SRS-RSRP history information from the target UL node 120 and neighbor UL nodes 123. To this end, the source gNB 110 may transmit a message requesting current UL SRS-RSRP and SRS-RSRP history information to the target UL node 120 and neighbor UL nodes 123.

In operation 414, the source gNB 110 may receive location information and movement-related data of the UE 100 from the UE 100. To this end, the source gNB 110 may transmit a message requesting location information and movement-related data to the UE 100.

The source gNB 110 may predict the movement path and UL RSRP of the UE 100 based on the information received from the adjacent UL nodes 120 and 123 and movement-related data received from the UE 100, and may determine an optimal target UL node based thereon.

In operation 415, the source gNB 110 may transmit an indicator indicating the occurrence of a UL node change to the UE 100 as an AI-UL output report. In operation 416, the source gNB 110 may transmit a message requesting a UL node change to the target UL node 120 as an AI-UL output report.

FIG. 5A illustrates a more detailed operation in which a UE receives AI-UL model setup information, performs inference on uplink, and transmits an AI-UL output report according to an embodiment of the disclosure. In FIG. 5A, it is assumed that the uplink node is changed to the target UL node when uplink transmission to the UE 100 is performed under the control of the gNB 110 and uplink transmission is performed under the control of the source UL node 121.

Referring to FIG. 5A, in operation 501, the UE 100 may perform a cell access procedure with the gNB 110 and the source UL node 121 according to a general procedure. The cell access procedure may include a radio resource control (RRC) setup, reconfiguration, and resetting procedure.

The UE 100 may receive information for AI-UL model setup from the gNB 110 in operation 502.

According to an embodiment, the information for AI-UL model setup may include basic information about the AI model (e.g., the number of layers, the number of nodes, connection information with nodes, the AI-UL model input/output format, and the activation function). According to an embodiment, the information for AI-UL model setup may include an UL node path loss calculation indicator, a target UL node determination indicator, or an indicator indicating whether to change the UL node as an indicator for determining the AI-UL model output type. According to an embodiment, the information for AI-UL model setup may include a message for triggering to allow the base station to perform AI inference or the inference period determined by the UE 100 considering the moving speed or remaining battery level or the period value determined during AI-UL model setup as the indicator indicating the type of the inference period. According to an embodiment, the information for AI-UL model setup may include information about the number of candidate target UL nodes to be reported by the UE 100. According to an embodiment, the information for AI-UL model setup may include information regarding, e.g., the event condition and threshold for UL node change as the information regarding the UL node change trigger event.

The UE 100 may receive an AI-UL input from the gNB 110 in operation 503. According to an embodiment, the AI-UL input may include location information, identification information, and cell/wireless capability information about the candidate UL node(s). According to an embodiment, considering a case in which the output type is changed after the AI-UL model setup information is transmitted, the AI-UL input may include an indicator indicating the output type of the AI model. According to an embodiment, the information to be reported by the UE 100 in the measurement configuration may be added to the indicator indicating the output type of the AI model, which may be set in the RRC reconfiguration information. According to an embodiment, an inference period may be included. When the inference period type indicator included in the AI-UL model setup indicates the period determined during the AI-UL model setup, the AI-UL input may include an indicator indicating a change in the AI inference period and a value indicating the changed period. When a triggering message for performing AI inference is transmitted from the base station as the inference period type indicator included in the AI-UL model setup, the AI-UL input may include trigger information for performing AI inference. According to an embodiment, the AI-UL input may include data related to the location and movement of the UE 100.

The UE 100 performs an inference operation on the uplink based on the received AI-UL model setup information and AI-UL input in operation 504, and may transmit an AI-UL output report to the source UL node 121 based on the inference result in operation 505. The AI-UL output report transmitted from the UE 100 to the source UL node 121 may be transferred to the gNB 110 in operation 506 and applied to the AI-UL mode managed by the gNB 110.

According to an embodiment, the UE 100 may request the source UL node 121 to change the UL node by inferring the optimal target UL node based on the current location, movement direction, and expected path loss of the UE 100 in the inference process for the uplink. In this case, the AI-UL output report may include the identifier of the optimal target UL node inferred by the UE 100, the number and identifier of candidate target UL node(s), the type of UL node change trigger event, and information about whether the event occurs. In an embodiment, the UL node change trigger event may be an event in which the reference signal received power (RSRP) for the candidate UL node exceeds a threshold, or an event in which the RSRP expected for the candidate UL node exceeds the RSRP expected for the source UL node 121.

According to an embodiment, the UE 100 may allow the source UL node 121 to determine whether to change the UL node by inferring the path loss expected for the candidate UL nodes in the inference process for the uplink and reporting it to the source UL node 121. In this case, the AI-UL output report may include information about the number of candidate target UL nodes and a set indicating path loss values of candidate UL nodes.

According to an embodiment, the UE 100 may infer a path loss expected for the source UL node 121 in the inference process for the uplink and request the source UL node 121 to change the UL node. In this case, the AI-UL output report may include location information and movement data of the UE 100, and information about whether the UL node change trigger event occurs. In an embodiment, the UL node change trigger event may be an event in which the RSRP expected for the source UL node 121 exceeds the threshold.

FIG. 5B illustrates an operation in which a gNB determines a target UL mode and a UL node change based on an AI-UL model managed by the gNB according to an embodiment of the disclosure. In FIG. 5B, it is assumed that the uplink node is changed to the target UL node when uplink transmission to the UE 100 is performed under the control of the gNB 110 and uplink transmission is performed under the control of the source UL node 121.

Referring to FIG. 5B, in operation 511, the UE 100 may perform a cell access procedure with the gNB 110 and the source UL node 121 according to a general procedure. The cell access procedure may include a radio resource control (RRC) setup, reconfiguration, and resetting procedure.

In operations 512 and 513, the gNB 110 may receive location information, identifier, cell capability information, and/or current UL SRS-RSRP and SRS-RSRP history information from the target UL node 122 and neighbor UL nodes 123. To this end, the gNB 110 may transmit a message requesting current UL SRS-RSRP and SRS-RSRP history information to the target UL node 122 and neighbor UL nodes 123.

In operations 514 and 515, the gNB 110 may receive location information and movement-related data of the UE 100 from the UE 100 through the source UL node 121. To this end, the gNB 110 may transmit a message requesting location information and movement-related data to the UE 100.

The gNB 110 may predict the movement path and UL RSRP of the UE 100 based on the information received from the adjacent UL nodes 122 and 123 and movement-related data received from the UE 100, and may determine an optimal target UL node based thereon.

In operation 516, the gNB 110 may transmit an indicator indicating the occurrence of a UL node change to the UE 100 as an AI-UL output report. In operation 517, the gNB 110 may transmit a message requesting a UL node change to the target UL node 121 as an AI-UL output report.

FIG. 6 illustrates an operation when a source gNB fails to change a UL node after a UE receives AI-UL model setup information, performs inference on uplink, and reports AI-UL output according to an embodiment of the disclosure. In FIG. 6, it is assumed that the uplink node is changed to the target UL node 120 when both downlink transmission and uplink transmission are performed on the UE 100 under the control of the source gNB 110.

Referring to FIG. 6, in operation 601, the UE 100 may perform a cell access procedure with a source base station (source gNB) 110 according to a general procedure. The cell access procedure may include a radio resource control (RRC) setup, reconfiguration, and resetting procedure.

The UE 100 may receive information for AI-UL model setup from the source gNB 110 in operation 602. The UE 100 may receive an AI-UL input from the source gNB 110 in operation 603. The UE 100 performs an inference operation on the uplink based on the received AI-UL model setup information and AI-UL input in operation 604, and may transmit an AI-UL output report to the source gNB 110 based on the inference result in operation 605.

According to an embodiment, when path loss-related information about the candidate UL nodes is included in the AI-UL output report, the source gNB 110 may periodically collect result values for the candidate UL nodes from the UE 100 and train the AI model based on the periodically collected result values for the candidate UL nodes.

According to an embodiment, when the AI-UL output report includes information about the optimal target UL node inferred by the UE 100 or information regarding the UL node change request, if the source gNB 110 fails to change the UL node in operation 606, the source gNB 110 may request AI-UL training data from the UE 100 to train the AI UL model in operation 607 and receive a path loss value for the candidate UL node calculated from the UE 100 in operation 608.

In FIG. 6, the case where the source gNB 110 controls the UL transmission to the UE 100 has been described as an example, but even when the source UL node controls the UL transmission to the UE 100 with the downlink and uplink separated, the source UL node may receive data for training the AI-UL model from the UE 100 as illustrated in FIG. 6.

FIG. 7 illustrates an operation of adding a UL node by a source gNB according to an embodiment of the disclosure. In FIG. 7, it is assumed that the uplink node is changed to the target UL node 120 when both downlink transmission and uplink transmission are performed on the UE 100 under the control of the source gNB 110.

Referring to FIG. 7, the source gNB 110 having determined to add a UL node may initiate a preparation operation for adding a UL node in operation 701.

In operation 702, the source gNB 110 may transmit a UL node addition and UL node change request message to the target UL node 120 for UL resource allocation to the UE 100. In an embodiment, the UL node addition request message may include the identifier of the UE 100, security capability information about the UE 100, and an indicator indicating the target UL node addition trigger event type. In an embodiment, when there are a plurality of target UL node candidates, the UL node addition request message may include information for determining an optimal target UL node and the number of target UL node candidates. Specifically, if there are a plurality of target UL node candidates, the UL node addition request message may include information about the maximum number of UL nodes that need to prepare for a UL node change and information indicating the probability that UE 100 is to arrive at the target node.

The target UL node 120 may add a UL node in operation 703, and may transmit a response message to the UL node addition request to the source gNB 110 in operation 704. The response message to the UL node addition request may include preamble allocation information for the UE 100.

FIG. 8 illustrates an operation of changing a UL node by a source UL node according to an embodiment of the disclosure. In FIG. 8, it is assumed that the uplink node is changed to the target UL node when uplink transmission to the UE 100 is performed under the control of the gNB 110 and uplink transmission is performed under the control of the source UL node 121.

Referring to FIG. 8, the source UL node 121 may determine a UL node change in operation 801 and start a preparation operation for the UL node change.

In operation 802, the source UL node 121 may transmit a UL node change request message to the gNB 110. In an embodiment, the source UL node 121 may transmit a UL node change request message to the gNB 110 based on the AI-UL model output report received from the UE 100 or the UL RSRP measured by the source UL node 121.

In an embodiment, the UL node change request message may include the identifier(s) of the target UL node measured by the UE 100, an indicator requesting the gNB 110 to determine the target UL node, and/or an indicator indicating that the UL RSRP measured by the source UL node 121 is lower than the threshold.

The gNB 110 may determine one of the identifier(s) of the target UL node measured by the UE 100 as the target UL node, or the gNB 110 may directly determine the target UL node. The gNB 110 determining the target UL node may transmit a UL node change identification message to the source UL node 121 in operation 803.

In an embodiment, the UL node change identification message may include an indicator that approves the target UL node determined by the source UL node 121. When the gNB 110 directly determines the target UL node, the UL node change identification message may include an indicator indicating the target UL node selected by the gNB 110.

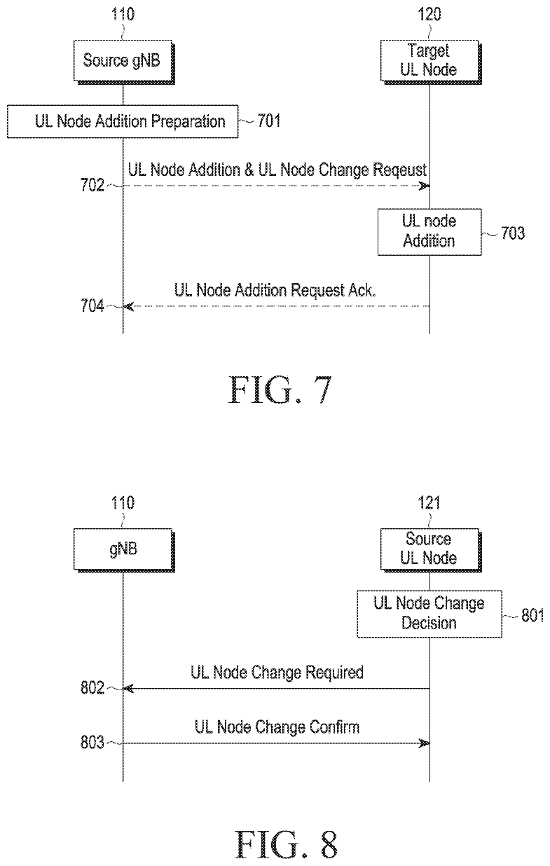

FIG. 9 illustrates a detailed operation of a UL node change procedure according to an embodiment of the disclosure. In FIG. 9, it is assumed that the uplink node is changed to the target UL node 120 when both downlink transmission and uplink transmission are performed on the UE 100 under the control of the source gNB 110.

The source gNB 110 may initiate the UL node change operation by transmitting an RRC reconfiguration message including an indicator indicating that a UL node change occurs and a target UL node identifier.

Referring to FIG. 9, in operation 901, the source gNB 110 may allocate a preamble to the UE 100 for uplink synchronization between the target UL node 120 and the UE 100 when changing the uplink node while maintaining the downlink. In an embodiment, when there are a plurality of target UL nodes, the source gNB 110 may allocate a plurality of preambles to the UE 100 so as to match the number of target UL nodes.

In operation 902, the UE 100 may transmit the preamble to the target UL node 120. In an embodiment, when a plurality of preambles are allocated from the source gNB 110, the UE 100 may select and transmit a preamble corresponding to the target UL node 120 from among the plurality of preambles.

In an embodiment, the transmission power at which the UE 100 transmits the preamble may be calculated using the path loss value estimated using the AI UL model and the preamble reception power of the target UL node 120 received in the RRC reconstruction process, as shown in Equation 1 below.

$${P}_{PRACH , b , f , c} ( i ) = min \{ {P}_{CMAX , f , c} ( i ) , {P}_{PRACH , target , f , c} + {PL}_{b , f , c} \} [ dBm ] \qquad [ Equation 1 ]$$

In Equation 1, P_{PRACHb,f,c}(i) denotes the output power of physical random access channel (PRACH) in the active UL bandwidth b of the carrier f of the serving cell c at the transmission occasion i, P_{CMAX,f,c}(i) denotes the maximum output power configured for the carrier f of the serving cell c at the transmission occasion i, P_{PRACH,target,f,c} denotes the PRACH target reception power in the active UL bandwidth b of the carrier f of the serving cell c, and PL_{b,f,c} denotes the path loss for the active UL bandwidth b of the carrier f of the serving cell c.

The target UL node 120 receiving the preamble from the UE 100 may transmit a random access response (RAR) to the source gNB 110 in operation 903, and the source gNB 110 may transfer the RAR to the UE 100 in operation 904. In an embodiment, the RAR may include preamble index information and a tracking area code (TAC), a UL grant, and a cell-radio network temporary identifier (C-RNTI) as medium access control (MAC) RAR information.

The UE 100 receiving the RAR may transmit a message 3 (msg 3) to the target UL node 120 in operation 905. In an embodiment, the msg3 message may include information for performing an RRC connection.

The target UL node 120 that has received msg 3 from the UE 100 may complete the UL node change operation by transmitting a UL node change complete message to the source gNB 110 in operation 906.

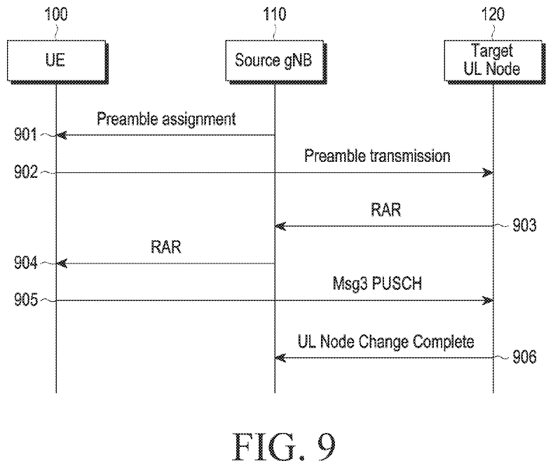

FIG. 10 illustrates a detailed operation of a UL node change procedure according to an embodiment of the disclosure. In FIG. 10, it is assumed that the uplink node is changed to the target UL node when uplink transmission to the UE 100 is performed under the control of the gNB 110 and uplink transmission is performed under the control of the source UL node 121.

The gNB 110 may initiate the UL node change operation by transmitting an RRC reconfiguration message including an indicator indicating that a UL node change occurs and a target UL node identifier.

Referring to FIG. 10, in operation 1001, the gNB 110 may allocate a preamble to the UE 100 for uplink synchronization between the target UL node 122 and the UE 100 when changing the uplink node while maintaining the downlink. In an embodiment, when there are a plurality of target UL nodes, the gNB 110 may allocate a plurality of preambles to the UE 100 so as to match the number of target UL nodes.

In operation 1002, the UE 100 may transmit the preamble to the target UL node 122. In an embodiment, when a plurality of preambles are allocated from the gNB 110, the UE 100 may select and transmit a preamble corresponding to the target UL node 122 from among the plurality of preambles.

In an embodiment, the transmission power at which the UE 100 transmits the preamble may be calculated using the path loss value estimated using the AI UL model and the preamble reception power of the target UL node 122 received in the RRC reconstruction process, as shown in Equation 2 below.

$${P}_{PRACH , b , f , c} ( i ) = min \{ {P}_{CMAX , f , c} ( i ) , {P}_{PRACH , target , f , c} + {PL}_{b , f , c} \} [ dBm ] \qquad [ Equation 2 ]$$

In Equation 2, P_{PRACHb,f,c}(i) denotes the output power of physical random access channel (PRACH) in the active UL bandwidth b of the carrier f of the serving cell c at the transmission occasion i, P_{CMAX,f,c}(i) denotes the maximum output power configured for the carrier f of the serving cell c at the transmission occasion i, P_{PRACH,target,f,c} denotes the PRACH target reception power in the active UL bandwidth b of the carrier f of the serving cell c, and PL_{b,f,c} denotes the path loss for the active UL bandwidth b of the carrier f of the serving cell c.

The target UL node 122 receiving the preamble from the UE 100 may transmit an RAR to the gNB 110 in operation 1003, and the gNB 110 may transfer the RAR to the UE 100 in operation 1004. In an embodiment, the RAR may include preamble index information and a tracking area code (TAC), a UL grant, and a cell-radio network temporary identifier (C-RNTI) as medium access control (MAC) RAR information.

The UE 100 receiving the RAR may transmit a message 3 (msg 3) to the target UL node 122 in operation 1005. In an embodiment, the msg3 message may include information for performing an RRC connection.

The target UL node 122 that receives msg 3 from the UE 100 may transmit a UL node change complete message to the gNB 110 in operation 1006 and, in operation 1007, the gNB 110 may transmit a UL node change complete message and a source UL node release request message to the source UL node 121, thereby completing the UL node change operation. In an embodiment, the gNB 110 may also transmit, to the neighbor UL node(s) 123, a message indicating that the target UL node 122 is determined and the UL node change is completed.

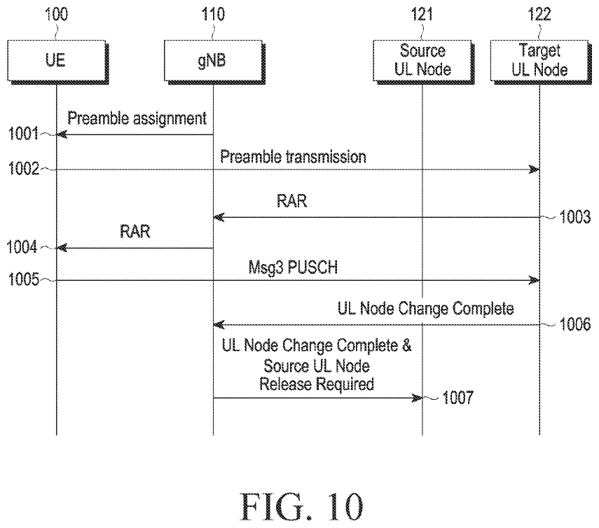

FIG. 11 is a view illustrating a configuration of a node according to an embodiment of the disclosure. In FIG. 11, the node may be a concept including at least one of a gNB, a source gNB, a source UL node, a target UL node, and a neighbor UL node according to an embodiment disclosed in FIGS. 1 to 10 of the disclosure.

Referring to FIG. 11, the node 1100 may include a controller (or processor) 1110 that controls the overall operation of the node 1100 according to an embodiment disclosed in FIGS. 1 to 10 of the disclosure, a transceiver 1120 including a transmitter and a receiver, and memory (not illustrated). The components of the node are not limited to the example, and the node may include more or fewer components than those illustrated in FIG. 11.

According to an embodiment of the disclosure, the transceiver 1120 may transmit/receive signals to and from at least one of other devices (or nodes) or the UE. The signal transmitted/received with at least one of the other device (or node) or the UE may include control information and data.

According to an embodiment of the disclosure, the controller 1110 may control the node 1100 to perform any one of the above-described embodiments. Meanwhile, the controller 1110 and the transceiver 1120 are not necessarily implemented in separate modules but rather as a single component, e.g., a single chip. The controller 1110 and the transceiver 1120 may be electrically connected. The controller 1110 may be an application processor (AP), a communication processor (CP), a circuit, an application-specific circuit, or at least one processor.

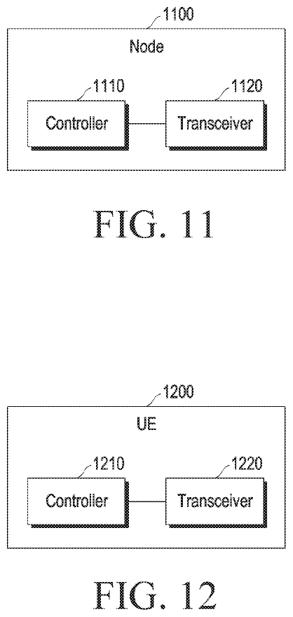

FIG. 12 is a view illustrating a configuration of a UE according to an embodiment of the disclosure.

Referring to FIG. 12, the UE (or terminal) 1200 according to an embodiment disclosed in FIGS. 1 to 10 of the disclosure may include a controller (or processor) 1210 for controlling the overall operation of the UE 1200, a transceiver 1220 including a transmitter and a receiver, and memory (not shown). The configuration of the UE is not limited thereto, and the UE may include more or less components than those shown in FIG. 12. The UE 1200 may be a concept including the UEs disclosed in FIGS. 1 to 10.

According to an embodiment of the disclosure, the transceiver 1220 may transmit/receive signals to/from other devices (or nodes). The signals transmitted/received with at least one of the other devices (or nodes) may include control information and data.

According to an embodiment of the disclosure, the controller 1210 may control the UE 1200 to perform any one of the above-described embodiments. Meanwhile, the controller 1210 and the transceiver 1220 are not necessarily implemented in separate modules but rather as a single component, e.g., a single chip. The controller 1210 and the transceiver 1220 may be electrically connected. The controller 1210 may be an application processor (AP), a communication processor (CP), a circuit, an application-specific circuit, or at least one processor.

It should be noted that the above-described configuration views, example views of control/data signal transmission methods, example views of operational procedures, and configuration views are not intended as limiting the scope of the disclosure. In other words, all the components, entities, or operational steps described in connection with the embodiments should not be construed as essential components to practice the present invention, and the present invention may be rather implemented with only some of the components without departing from the gist of the present invention. The embodiments may be practiced in combination, as necessary. For example, some of the methods proposed herein may be combined to operate the network entity and the UE.

The above-described operations of the base station or UE may be realized by equipping a memory device retaining their corresponding codes in the base station device or any component of the UE. That is, the controller in the eNB or terminal may execute the above-described operations by reading and executing the program codes stored in the memory device by a processor or central processing unit (CPU).

As described herein, various components or modules in the entity, base station or UE may be operated using a hardware circuit, e.g., a complementary metal oxide semiconductor-based logic circuit, firmware, software, and/or using a hardware circuit such as a combination of hardware, firmware, and/or software embedded in a machine-readable medium. As an example, various electric structures and methods may be executed using electric circuits such as transistors, logic gates, or ASICs.

When implemented in software, there may be provided a computer readable storage medium storing one or more programs (software modules). One or more programs stored in the computer readable storage medium are configured to be executed by one or more processors in an electronic device. One or more programs include instructions that enable the electronic device to execute methods according to the embodiments described in the specification or claims of the disclosure.

The programs (software modules or software) may be stored in random access memories, non-volatile memories including flash memories, read-only memories (ROMs), electrically erasable programmable read-only memories (EEPROMs), magnetic disc storage devices, compact-disc ROMs, digital versatile discs (DVDs), or other types of optical storage devices, or magnetic cassettes. Or, the programs may be stored in memory constituted of a combination of all or some thereof. As each constituting memory, multiple ones may be included.

The programs may be stored in attachable storage devices that may be accessed via a communication network, such as the Internet, Intranet, local area network (LAN), wide area network (WLAN), or storage area network (SAN) or a communication network configured of a combination thereof. The storage device may connect to the device that performs embodiments of the disclosure via an external port. A separate storage device over the communication network may be connected to the device that performs embodiments of the disclosure.

In the above-described specific embodiments, the components included in the disclosure are represented in singular or plural forms depending on specific embodiments proposed. However, the singular or plural forms are selected to be adequate for contexts suggested for ease of description, and the disclosure is not limited to singular or plural components. As used herein, the singular forms “a,” “an,” and “the” are intended to include the plural forms as well, unless the context clearly indicates otherwise.

Although specific embodiments of the present invention have been described above, various changes may be made thereto without departing from the scope of the present invention. Thus, the scope of the disclosure should not be limited to the above-described embodiments, and should rather be defined by the following claims and equivalents thereof. In other words, it is apparent to one of ordinary skill in the art that various changes may be made thereto without departing from the scope of the present invention. Further, the embodiments may be practiced in combination. For example, some of the methods proposed herein may be combined to operate the base station and the UE. Although the embodiments are proposed in association with 5G and NR systems, various modifications thereto may apply to other various systems, such as LTE, LTE-A, LTE-A-Pro systems.

Although specific embodiments of the present invention have been described above, various changes may be made thereto without departing from the scope of the present invention. Thus, the scope of the disclosure should not be limited to the above-described embodiments, and should rather be defined by the following claims and equivalents thereof.

1. A method for changing an uplink node by a first node in a wireless communication system, the method comprising:
transmitting, to a user equipment (UE), artificial intelligence (AI) uplink model setup information, and receiving, from the UE, an uplink inference result based on the AI uplink model setup information;
determining to add a second node as an uplink node for the UE based on the uplink inference result based on the AI uplink model setup information;
transmitting, to the second node, an uplink node addition request, and receiving, from the second node, a response to the uplink node addition request;
performing a random access procedure with the UE via the second node; and
receiving, from the second node, an uplink node change complete message.

2. The method of claim 1,
wherein the second node is an uplink-only node.

3. The method of claim 1, wherein the uplink inference result includes:
information on the second node, in case that an event occurs in which a reference signal received power (RSRP) expected for at least one uplink node including the second node exceeds a first threshold, or an event occurs in which the RSRP expected for the at least one uplink node including the second node exceeds an RSRP expected for the first node; and
information requesting uplink node change, in case that an event occurs in which the RSRP expected for the first node is less than a second threshold.

4. The method of claim 1, wherein performing the random access procedure with the UE via the second node includes:
allocating a preamble to the UE;
receiving, from the second node, a random access response; and
transmitting, to the UE, the random access response.

5. A method for changing an uplink node by a first node in a wireless communication system, the method comprising:
transmitting, to a user equipment (UE), artificial intelligence (AI) uplink model setup information;
receiving, from the UE via a second node, an uplink inference result based on the AI uplink model setup information;
receiving, from the second node, a request for changing an uplink node for the UE from the second node to a third node and transmitting, to the second node, a response to the request for changing the uplink node;
performing a random access procedure with the UE via the third node; and
receiving, from the third node, an uplink node change complete message, and transmitting, to the second node, the uplink node change complete message and a message for requesting uplink release of the second node.

6. The method of claim 5,
wherein the second node and the third node are uplink-only nodes.

7. The method of claim 5, wherein the uplink inference result includes:
information on the third node, in case that an event occurs in which a reference signal received power (RSRP) expected for at least one uplink node including the third node exceeds a first threshold, or an event occurs in which the RSRP expected for the at least one uplink node including the third node exceeds an RSRP expected for the second node; and
information requesting uplink node change, in case that an event occurs in which the RSRP expected for the second node is less than a second threshold.

8. The method of claim 5, wherein performing the random access procedure with the UE via the third node includes:
allocating a preamble to the UE;
receiving, from the third node, a random access response; and
transmitting, to the UE, the random access response.

9. A first node in a wireless communication system, comprising:
a transceiver; and
at least one processor, wherein the at least one processor is configured to:
transmit, to a user equipment (UE), artificial intelligence (AI) uplink model setup information and receive, from the UE, an uplink inference result based on the AI uplink model setup information;
determine to add a second node as an uplink node for the UE based on the uplink inference result based on the AI uplink model setup information;
transmit, to the second node, an uplink node addition request and receive, from the second node, a response to the uplink node addition request;
perform a random access procedure with the UE via the second node; and
receive, from the second node, an uplink node change complete message.

10. The first node of claim 9,
wherein the second node is an uplink-only node.

11. The first node of claim 9, wherein the at least one processor is configured to perform the random access procedure with the UE via the second node by allocating a preamble to the UE, receiving, from the second node, a random access response, and transmitting, to the UE, the random access response.

12. A first node in a wireless communication system, comprising:
a transceiver; and
at least one processor, wherein the at least one processor is configured to:
transmit, to a user equipment (UE), artificial intelligence (AI) uplink model setup information;
receive, from the UE via a second node, an uplink inference result based on the AI uplink model setup information;
receive, from the second node, a request for changing an uplink node for the UE from the second node to a third node and transmit, to the second node, a response to the request for changing the uplink node;
perform a random access procedure with the UE via the third node; and
receive, from the third node, an uplink node change complete message and transmit, to the second node, the uplink node change complete message and a message for requesting uplink release of the second node.

13. The first node of claim 12,
wherein the second node and the third node are uplink-only nodes.

14. The first node of claim 12, wherein the uplink inference result includes:
information on the third node, in case that an event occurs in which a reference signal received power (RSRP) expected for at least one uplink node including the third node exceeds a first threshold or an event occurs in which the RSRP expected for the at least one uplink node including the third node exceeds an RSRP expected for the second node; and
information requesting uplink node change, in case that an event occurs in which the RSRP expected for the second node is less than a second threshold.

15. The first node of claim 12, wherein the at least one processor is configured to perform the random access procedure with the UE via the third node by:
allocating a preamble to the UE;
receiving, from the third node, a random access response; and
transmitting, to the UE, the random access response.

16. The first node of claim 12,
wherein the uplink model setup information includes an indicator indicating a type of the uplink inference result and information regarding a reporting period of the uplink inference result,
wherein the type of the uplink inference result includes one of:
a path loss value for at least one uplink node including the third node,
information on the third node, or
information requesting uplink node change.

17. The method of claim 1,
wherein the uplink model setup information includes an indicator indicating a type of the uplink inference result and information regarding a reporting period of the uplink inference result, and
wherein the type of the uplink inference result includes one of:
a path loss value for at least one uplink node including the second node,
information on the second node, or
information requesting uplink node change.

18. The method of claim 5,
wherein the uplink model setup information includes an indicator indicating a type of the uplink inference result and information regarding a reporting period of the uplink inference result, and
wherein the type of the uplink inference result includes one of:
a path loss value for at least one uplink node including the third node,
information on the third node, or
information requesting uplink node change.

19. The first node of claim 9,
wherein the uplink model setup information includes an indicator indicating a type of the uplink inference result and information regarding a reporting period of the uplink inference result,
wherein the type of the uplink inference result includes one of:
a path loss value for at least one uplink node including the second node,
information on the second node, or
information requesting uplink node change.

20. The first node of claim 9,
wherein the uplink inference result includes:
information on the second node, in case that an event occurs in which a reference signal received power (RSRP) expected for at least one uplink node including the second node exceeds a first threshold or an event occurs in which the RSRP expected for the at least one uplink node including the second node exceeds an RSRP expected for the first node; and
information requesting uplink node change, in case that an event occurs in which the RSRP expected for the first node is less than a second threshold.
